(19) United States
(12) Patent Application Publication
(10) Pub. No.: US 2004/0075579 A1
(43) Pub. Date: Apr. 22, 2004

(54) Emergency vehicle collision avoidance transponder (EVCAT)

(76) Inventor: Mark Paul Golightly, Williamsburg, OH (US)

Correspondence Address: MARK P. GOLIGHTLY, 172 KERMIT, AVE, WILLIAMSBURG, OH, 45176, US

(21) Appl. No.: 10/274,541

(22) Filed: Oct. 21, 2002

(51) Int. Cl. G08G 1/16

(52) U.S. Cl. 340/903

(57) ABSTRACT

The “Emergency Vehicle Collision Avoidance Transponder” is a pre-warning device that alerts the driving public to emergency vehicle traffic in the immediate area. Thus decreasing the risk of collision between an emergency vehicle, in an emergency situation, and an unsuspecting vehicle that has not heard the siren or seen the emergency lights on the emergency vehicle.

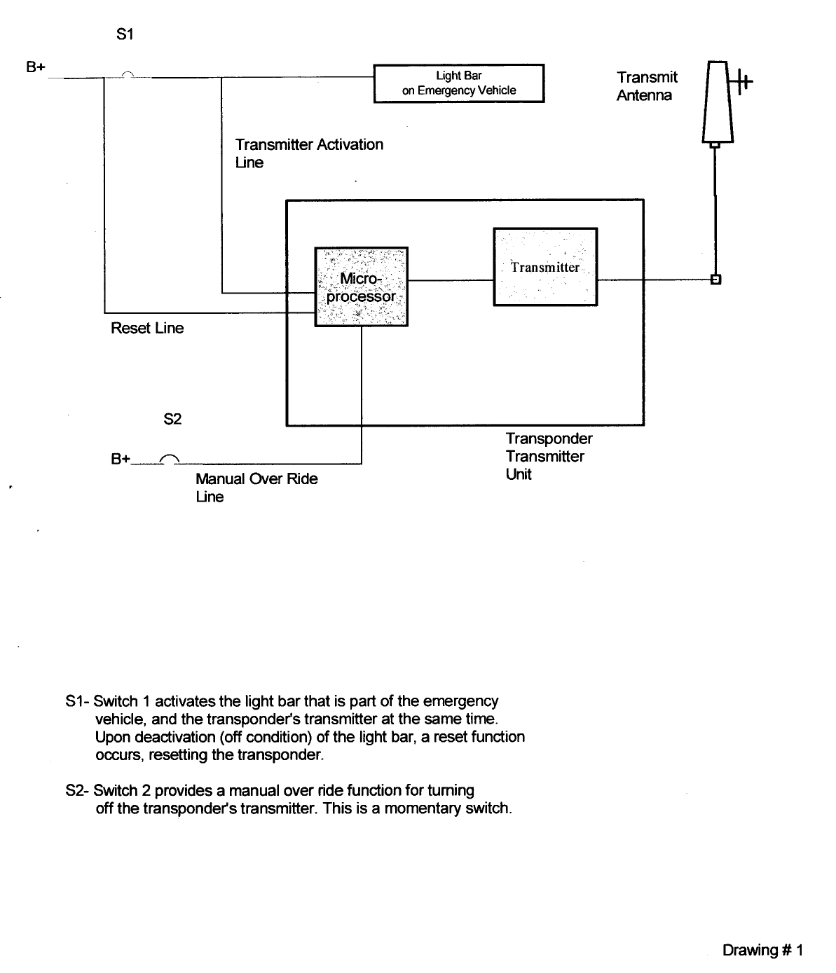

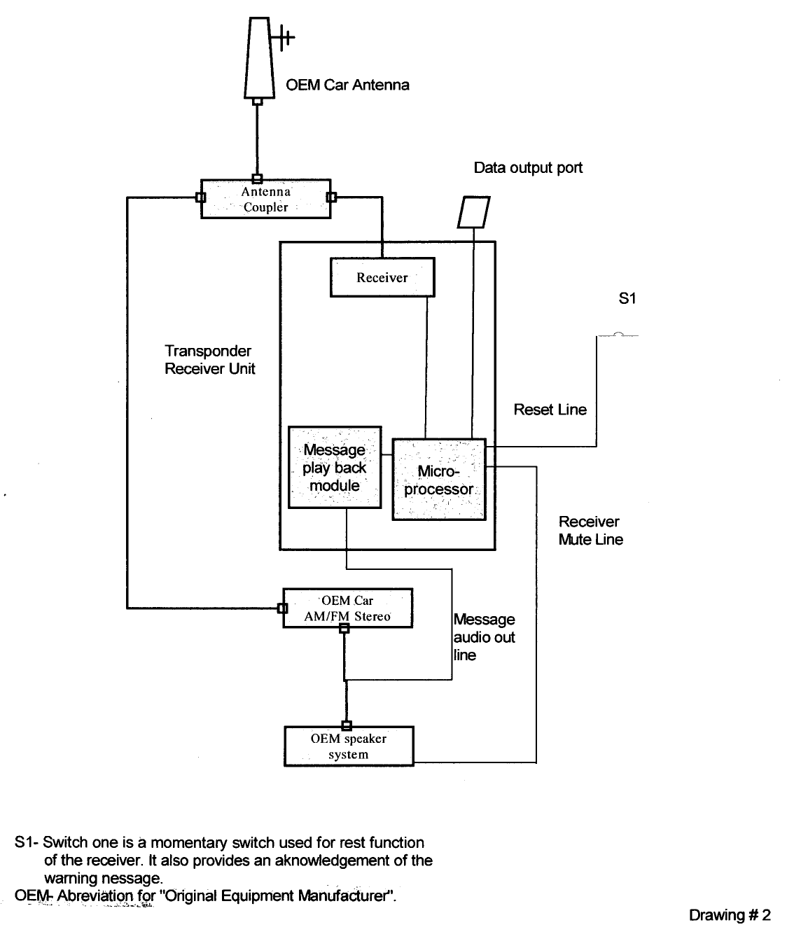

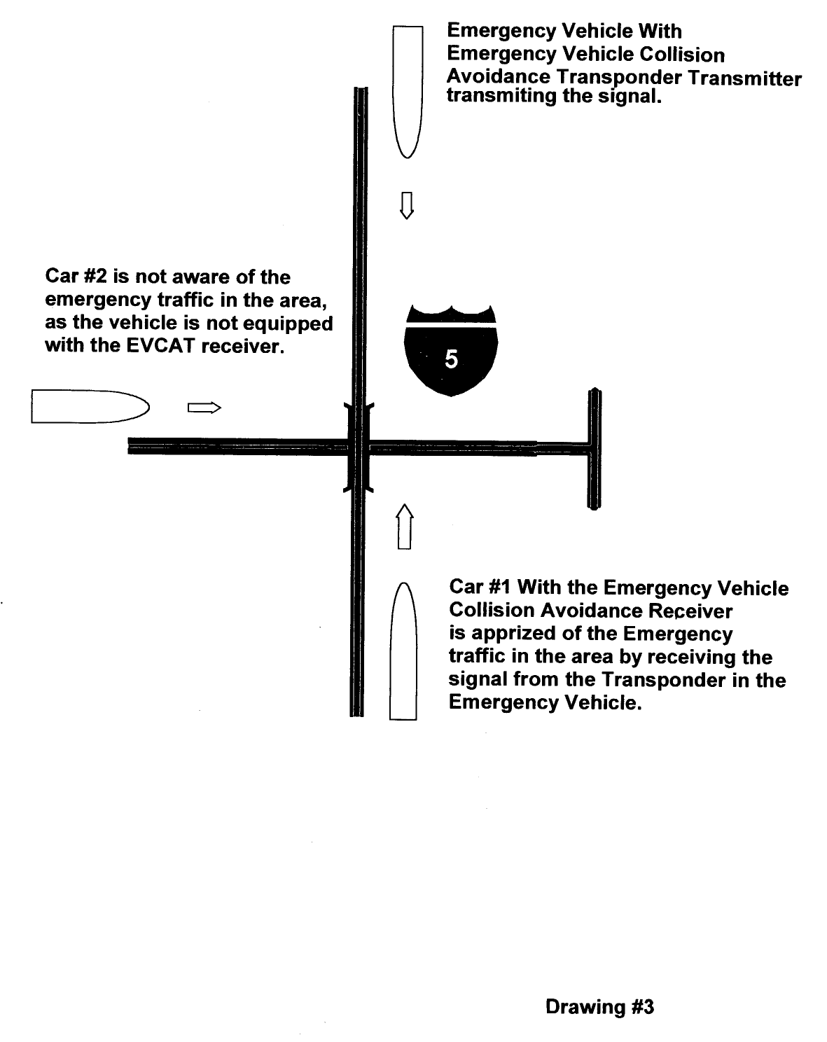

The benefit from such a device is increased public safety to the driving and traveling public by reducing the risk of these costly and devastating accidents.

### BACK GROUND NOMENCLATURE

The design and construction of the modem automobile has in many ways created an unexpected safety hazzard that the driving public has little knowledge of. Modern day vehicles with their enhanced sound proofing, significantly attenuate outside ambient noise, add in the on board stereo system and the outside ambient noise is even further attenuated. This greatly reduces the operators ability to hear approaching “Emergency Vehicles” (i.e. Sirens, Airhorns etc) until the “Emergency Vehicle” is too close.

Side to side vision in a vehicle is not always 180 degrees. Depending on the vehicle, the side to side may be reduced significantly or even occluded. These factors contribute greatly to collisions with “Emergency Vehicles” (i.e. Fire Trucks, Ambulances, Police Cars). Collisions occur frequently.

These accidents are exceptionally costly by comparison to car on car accidents. Fire apparatus vehicles can cost in the range of $250,000.00-500,000.00 or more depending upon the specification of the vehicle when it was built.

### PURPOSE OF THE EMERGENCY VEHICLE COLLISION AVOIDANCE TRANSPONDER

The primary purpose of the “Emergency Vehicle Collision Avoidance Transponder” (EVCAT) is collision avoidance of the driving public with emergency vehicles when these vehicles are deployed in an emergency. There by enhancing the safety of the driving public and extra safety for the crew of the emergency vehicle.

### OPERATIONAL THEORY

### I. Transponder Transmit Theory

The transponder's transmitter is connected to the activation switch of the “Light Bar” of the emergency vehicle. Thus upon the activation of the “Light Bar” of the emergency vehicle the transponder's transmitter is activated as well.

The transponder's transmitter will continually send out a radio signal with a digital code embedded in the signal stream, this is done in order to keep the false activation of the receiver to a minimum. The digital code only has to be rudimentary.

The transmitter power output should be in the range of a (½) half to (1) one watt of (RF) Radio Frequency power ( measured as Effective Radiated Power—ERP). The goal here is to achieve one quarter to one half mile distance of coverage.

The transponder's transmitter antenna should be directional yielding 180 degrees of radiated pattern forward of the emergency vehicle. Radiated projection to the rear of the emergency vehicle is not essential.

A manual over ride switch connected to the microprocessor of the transponder's transmitter is provided to over ride the transmitter in a multi emergency vehicle or department deployment, effectively turning off the transponders transmitter. This should only be done when arrival at the scene. Reset of this function is achieved through the microprocessor when the “Light Bar” activation switch is turned off. This facilitates the reset function of the transponder's transmitter while minimizing the human factor (i.e. forgetting to reset the device).

### II. Receiver Operational Theory

The transponder's receiver unit is located in personally owned vehicles of John Q. Public.

Upon receipt of the signal from the transponder the receiver will mute the vehicle's stereo, if on, and a warning message that emergency traffic is in the area will be played through the vehicle's speaker system. Thus alerting the driver that there is emergency vehicle traffic nearby.

The audio warning will repeat twice with a (1) one second delay between messages.

A reset switch located on the dash will reset the receiver and provide a recorded record in the microprocessor that the driver acknowledges the warning. This data can be down loaded a latter date if need be.

The receiver antenna can be the vehicle's own antenna used for AM/FM of the stereo. This can be accomplished by the use of a antenna coupler.

### SUMMARY OF OPERATION

I. Upon activation of the Light Bar switch in the emergency vehicle, the transponder's transmitter starts transmitting it's digital signal.

II. Upon receipt of the signal from the transponder, the receiver (through the microprocessor) will mute the vehicle's audio system and play a warning message that there is emergency traffic in the immediate area. The message will play twice with a (1) one second interval between.

III. The driver will activate the reset switch on the dash acknowledging the warning that there is emergency traffic.

1. What I claim as my invention is the “Emergency Vehicle Collision Avoidance Transponder” (ECAT) consisting of two units. A Transponder Transmitter unit and the Transponder Receiver unit, the associated deployment technique's of the device and use of said device as described in the submitted documents and drawings.
